(19) United States
(12) Patent Application Publication
(10) Pub. No.: US 2008/0204484 A1
(43) Pub. Date: Aug. 28, 2008

(54) SERIAL PRINTER AND METHOD FOR CONTROLLING PRINTING OPERATION THEREOF

(75) Inventor: Toshihiro KUMAGAI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/034,381

(22) Filed: Feb. 20, 2008

(30) Foreign Application Priority Data
Feb. 22, 2007 (JP) 2007-042144

(51) Int. Cl. B41J 29/38

(52) U.S. Cl. 347/5

(57) ABSTRACT

A serial printer includes a first direction-determining unit that determines a carriage moving direction for a subsequent printing pass that follows a current printing pass, in which a carriage is currently moving, on the basis of a target position at which the carriage is to stop. The printer also includes a printing-information-calculating unit that calculates printing information necessary for executing the subsequent pass, on the basis of the carriage moving direction determined by the first direction-determining unit. A second direction-determining unit determines a carriage moving direction for the subsequent pass on the basis of an actual carriage stop position. A printing execution unit executes printing in accordance with the printing information calculated by the first printing-information-calculating unit. The printing is executed if it is determined that the carriage moving directions detected by first and second direction-determining units are the same.

### BACKGROUND

1. Technical Field

The present invention relates to serial printers and methods for controlling printing operation of the serial printers, and more particularly to serial printers designed for reduced printing time and methods for controlling printing operation of the serial printers.

2. Related Art

Ink jet printers are typical examples of serial printers. An ink jet printer performs printing operation on a printing medium by applying a voltage to piezoelectric elements provided in correspondence with nozzles of a print head mounted on a carriage to eject ink droplets through the nozzles utilizing expanding/contracting movement of the piezoelectric elements while moving the carriage.

Therefore, a printing information calculation process for calculating what type of printing operation is to be performed in a subsequent printing pass needs to be completed before the carriage starts moving for execution of the subsequent printing pass. That is, it is necessary to execute the printing information calculation process so as to calculate information such as the direction of carriage movement in the subsequent printing pass, printing start and end positions for the subsequent printing pass, and head-driving waveform data to be supplied to the print head during printing operation.

For example, referring to FIG. 1, after the completion of printing operation based on a printing request n−1 for executing a printing pass n−1, a paper feeding request is sent to a paper feeding motor. In accordance with the paper feeding request, the paper feeding motor feeds a printing medium by a predetermined length so that the printing medium has a portion thereof to be subjected to a subsequent printing pass n positioned at the print head.

Simultaneously with the paper feeding operation, a carriage motor decelerates and stops the carriage. After the carriage is stopped, the serial printer that has accepted a printing request n for executing the printing pass n executes the printing information calculation process for executing the subsequent printing pass n. In the printing information calculation process, the printing direction for the subsequent printing pass n is determined on the basis of an actual stop position, which is a position where the carriage has actually stopped. That is, whether the carriage should be moved from right to left or from left to right in executing the subsequent printing pass n is determined. Such a process for determining the printing direction is called logical seeking. An example of a logical seeking process is disclosed in JP-A-58-7383.

In the printing information calculation process, printing start and end positions in executing printing by moving the carriage in a direction determined in the logical seeking process are calculated on the basis of the printing request n. Further, in the printing information calculation process, head-driving waveform data to be supplied to the print head mounted on the carriage while the carriage moves from the printing start position to the printing end position is generated on the basis of the printing request n. The print head is driven in accordance with a driving signal generated on the basis of the head driving waveform data so as to execute printing by ejecting ink droplets onto the printing medium.

In the example shown in FIG. 1, since the printing information calculation process is completed during the paper feeding process, printing on the printing medium can be started immediately after the paper feeding motor stops. That is, after the paper feeding is completed, the carriage moves at a constant speed and can perform printing by ejecting ink droplets from the print head.

FIG. 2 shows the case where the carriage is still moving at the moment when the printing request n for the subsequent printing pass n is accepted. In such a case, since the position at which the carriage stops is yet to be determined, logical seeking is not available. This means that the printing information calculation process is unexecutable before the carriage stops. Therefore, processing required for executing the subsequent printing pass cannot be performed before the paper feeding process is completed, whereby a waiting time occurs after the completion of the paper feeding process. That is, printing for the subsequent printing pass n by ejection of ink droplets cannot be performed immediately after the completion of the paper feeding process.

Printing on the printing medium proceeds in the manner of alternating acceptance of printing requests and paper feeding requests. If the waiting time for stoppage of the carriage as described above occurs for every printing pass, much time is wasted before the completion of printing on the entire printing medium. Accordingly, the total printing time increases. Consequently, a user needs to wait for a longer time before completion of printing.

To avoid such a problem, JP-A-62-257873 discloses a serial printer in which information required for executing a subsequent printing pass is generated when a carriage starts to decelerate at the completion of a printing pass. However, the serial printer disclosed in JP-A-62-257873 does not perform logical seeking. This means that efficient control of carriage movement is not necessarily realized.

### SUMMARY

An advantage of some aspects of the invention is that it provides a serial printer designed for reduced total printing time while realizing efficient control of carriage movement, and a method for controlling printing operation of the serial printer.

According to a first aspect of the invention, a serial printer includes a first moving-direction-determining unit that determines a carriage moving direction for a subsequent printing pass that follows a current printing pass, in which a carriage is currently moving, on the basis of a target position at which the carriage is to be stopped in the current pass, the carriage moving direction being determined before the carriage stops; a first printing-information-calculating unit that calculates printing information necessary for executing the subsequent pass, on the basis of the carriage moving direction determined by the first moving-direction-determining unit; a second moving-direction-determining unit that determines a carriage moving direction for the subsequent pass on the basis of an actual stop position, at which the carriage actually stops, the carriage moving direction being determined after the carriage stops; a matching check unit that checks whether or not the carriage moving direction determined by the first moving-direction-determining unit matches the carriage moving direction determined by the second moving-direction-determining unit; and a printing execution unit that executes printing in accordance with the printing information calculated by the first printing-information-calculating unit, the printing being executed if the matching check unit determines that the carriage moving direction determined by the first moving-direction-determining unit matches the carriage moving direction determined by the second moving-direction-determining unit.

It is preferable that the serial printer further include a second printing-information-calculating unit that calculates printing information necessary for executing the subsequent pass, on the basis of the carriage moving direction determined by the second moving-direction-determining unit, the printing information being calculated if the matching check unit determines that the carriage moving direction determined by the first moving-direction-determining unit does not match the carriage moving direction determined by the second moving-direction-determining unit. If the matching check unit determines that the carriage moving direction determined by the first moving-direction-determining unit does not match the carriage moving direction determined by the second moving-direction-determining unit, the printing execution unit executes printing in accordance with the printing information calculated by the second printing-information-calculating unit.

In the serial printer, it is also preferable that, if the actual stop position of the carriage matches the target position set for the current pass, the matching check unit determine that the carriage moving direction determined by the first moving-direction-determining unit matches the carriage moving direction determined by the second moving-direction-determining unit.

It is also preferable that, if a printing request for the subsequent pass is accepted, the first moving-direction-determining unit determine the carriage moving direction for the subsequent pass on the basis of the target position of the carriage for the current pass, and that the first printing-information-calculating unit calculate the printing information necessary for executing the subsequent pass on the basis of both the carriage moving direction determined by the first moving-direction-determining unit and the printing request for the subsequent pass.

It is also preferable that printing on a printing medium be performed by alternately accepting a printing request for a single printing pass and a printing medium transportation request, and that the printing request for the subsequent pass be acceptable while operation for transporting the printing medium is underway in accordance with the printing medium transportation request.

It is also preferable that the printing information calculated by the first printing-information-calculating unit and the printing information calculated by the second printing-information-calculating unit contain information on the subsequent pass including at least a printing start position, a printing end position, and head-driving waveform data to be supplied to a print head mounted on the carriage.

According to a second aspect of the invention, a method for controlling printing operation of a serial printer includes determining a carriage moving direction for a subsequent printing pass that follows a current printing pass, in which a carriage is currently moving, on the basis of a target position at which the carriage is to be stopped in the current pass, the carriage moving direction being determined before the carriage stops; calculating printing information necessary for executing the subsequent pass, on the basis of the carriage moving direction determined on the basis of the target position of the carriage; determining a carriage moving direction for the subsequent pass on the basis of an actual stop position, at which the carriage actually stops, the carriage moving direction being determined after the carriage stops; checking whether or not the carriage moving direction determined on the basis of the target position of the carriage matches the carriage moving direction determined on the basis of the actual stop position of the carriage; and executing printing in accordance with the calculated printing information if it is determined that the carriage moving direction determined on the basis of the target position of the carriage matches the carriage moving direction determined on the basis of the actual stop position of the carriage.

### BRIEF DESCRIPTION OF THE DRAWINGS

The invention will be described with reference to the accompanying drawings, wherein like numbers reference like elements.

FIG. 1 shows exemplary operational waveforms of a carriage motor and a paper feeding motor included in a known printer.

FIG. 2 shows other exemplary operational waveforms of the carriage motor and the paper feeding motor included in the known printer.

FIG. 3 is a perspective view showing an exemplary internal configuration of a printer according to an embodiment.

FIG. 4 is a schematic cross-sectional view showing the exemplary internal configuration of the printer shown in FIG. 3.

FIG. 5 is a block diagram showing an exemplary internal electrical configuration of the printer shown in FIG. 3.

FIG. 6 shows exemplary operational waveforms of a carriage motor and a paper feeding motor of the printer according to the embodiment.

FIG. 7 is a first part of a flowchart showing the contents of a printing control process executed by the printer shown in FIG. 3.

FIG. 8 is a second part of the flowchart showing the contents of the printing control process executed by the printer shown in FIG. 3.

FIG. 9 shows the relationships between actual stop positions and target positions in sequential printing passes.

FIG. 10 shows an exemplary case where a carriage moves in the same direction for two sequential printing passes.

### DESCRIPTION OF EXEMPLARY EMBODIMENTS

An embodiment of the invention will now be described with reference to the drawings. The following embodiment is not intended to limit the scope of the invention.

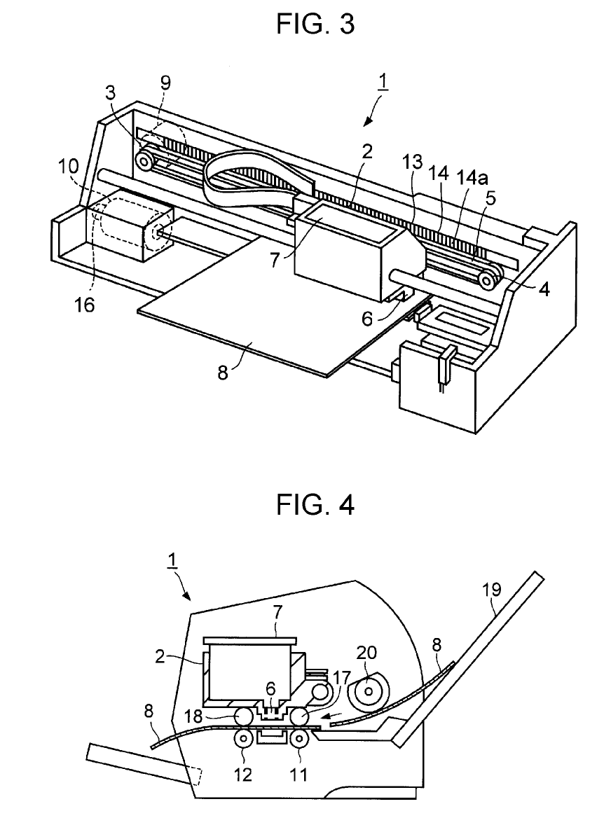

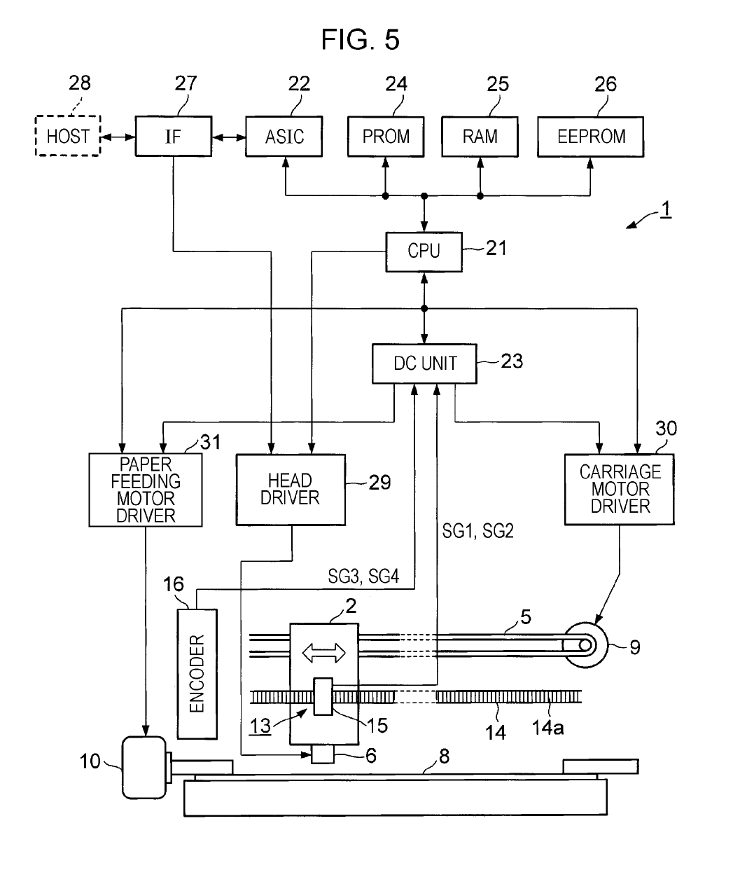

FIG. 3 is a perspective view showing the internal configuration of an ink jet printer 1, a serial printer, according to the embodiment. FIG. 4 is a schematic cross-sectional view roughly showing the internal configuration of the printer 1. FIG. 5 is a block diagram showing the electrical configuration of the printer 1.

Referring to FIG. 3, the printer 1 includes a carriage 2 inside thereof. The carriage 2 is attached to an endless timing belt 5 that is stretched between a driving pulley 3 and a driven pulley 4. The carriage 2 has on the bottom thereof a print head 6 and on the top thereof a detachable ink cartridge 7 that supplies ink to the print head 6. The print head 6 is provided with a plurality of nozzles through which ink droplets are ejected toward a paper sheet 8, a printing medium, at a predetermined timing.

The printer 1 has in the rear portion thereof a carriage motor 9 as a carriage driving unit. The carriage motor 9, which is a direct-current (DC) motor, reciprocates the carriage 2 in a main scanning direction by using the timing belt 5. The printer 1 also has in a bottom end portion thereof a paper feeding motor 10 as a transportation/driving unit. The paper feeding motor 10, which is a DC motor, drives a transportation roller 11 and a paper ejection roller 12 (see FIG. 4) and transports the paper sheet 8, the printing medium, in a sub-scanning direction.

The printer 1 also has in a side portion thereof a linear encoder 13 for detecting, for example, the speed, moving direction, and position of the carriage 2. The linear encoder 13 is constituted by a translucent resin tape (hereinafter simply referred to as a tape) 14, which is to be detected, extending transversely on an internal sidewall of the printer 1, and a detection sensor 15 (see FIG. 5) secured to the back of the carriage 2. The tape 14 has a plurality of slits 14a arranged next to each other along the longitudinal direction of the tape 14 at a constant pitch. When the carriage 2 moves, the detection sensor 15 detects some of the slits 14a and outputs two detection signals (pulse signals) SG1 and SG2 whose phases differ from each other by 90 degrees.

The output shaft of the paper feeding motor 10 is provided with a rotary encoder 16 as a detection unit for detecting, for example, the speed, direction, and position of paper feeding. The rotary encoder 16 basically has the same configuration as the linear encoder 13 except that it includes a rotating plate whose tape to be detected rotates with the rotation of the paper feeding motor 10. During paper feeding operation, the rotary encoder 16 detects some of slits provided in the rotating plate that rotates with the paper feeding motor 10 and outputs two detection signals (detected values) SG3 and SG4 in a form of pulses whose phases differ from each other by 90 degrees.

Referring to FIG. 4, the transportation roller 11 and the paper ejection roller 12 are disposed below the print head 6 and are driven by the paper feeding motor 10. The transportation roller 11 resides on the upstream side in the paper feeding direction, and the paper ejection roller 12 resides on the downstream side. The transportation roller 11 and the paper ejection roller 12 are paired with respective follower rollers 17 and 18 that follow the rotation thereof during paper feeding operation.

A paper feeding roller 20 is disposed at a position opposite a paper feeding tray 19. The paper feeding roller 20 is connected to the paper feeding motor 10 with a gear mechanism (not shown) provided therebetween and is driven by the paper feeding motor 10 as in the case of the rollers 11 and 12. The gear mechanism switches the connection state such that the paper feeding motor 10 is connected to the paper feeding roller 20 during paper feeding but is disconnected therefrom after paper feeding. The paper sheet 8 on the paper feeding tray 19 is fed into the printer 1 by the rotation of the paper feeding roller 20. The paper sheet 8 that has been fed into the printer 1 is transported by the transportation roller 11 and the paper ejection roller 12.

Referring to FIG. 5, the printer 1 has a central processing unit (CPU) 21, an application-specific integrated circuit (ASIC) 22, a DC unit 23, memory units including a programmable read-only memory (PROM) 24, a random-access memory (RAM) 25, and an electrically erasable programmable read-only memory (EEPROM) 26, and an interface (I/F) 27. The ASIC 22 exchanges various data (such as printing data) with a host computer (such as a personal computer) 28 via the I/F 27. The ASIC 22 controls the printing resolution and the driving waveform of the print head 6, for example, in accordance with the printing data sent from the host computer 28.

The CPU 21 controls the entirety of the printer 1. The CPU 21 sets the actuation and traveling schedules of the carriage motor 9 and the paper feeding motor 10 and the printing schedule of the print head 6 in accordance with the printing data taken from the host computer 28 via the I/F 27 and the ASIC 22. Then, the CPU 21 drives and controls the print head 6 via a driver 29 in accordance with the preset printing schedule. Further, the CPU 21 outputs a command signal based on the actuation and traveling schedules to the DC unit 23.

The DC unit 23 drives and controls the carriage motor 9 via a driver 30 in accordance with the command signal, and drives and controls the paper feeding motor 10 via a driver 31. When the carriage 2 is driven, the pulse signals SG1 and SG2 are input from the detection sensor 15 of the linear encoder 13 to the DC unit 23. In response to this, the DC unit 23 calculates the moving speed, moving direction, and position of the carriage 2. In the paper feeding process, the pulse signals SG3 and SG4 are input from the rotary encoder 16 to the DC unit 23. In response to this, the DC unit 23 calculates the driving speed, driving direction, and driving position (speed, direction, and position of paper feeding) of the paper feeding motor 10.

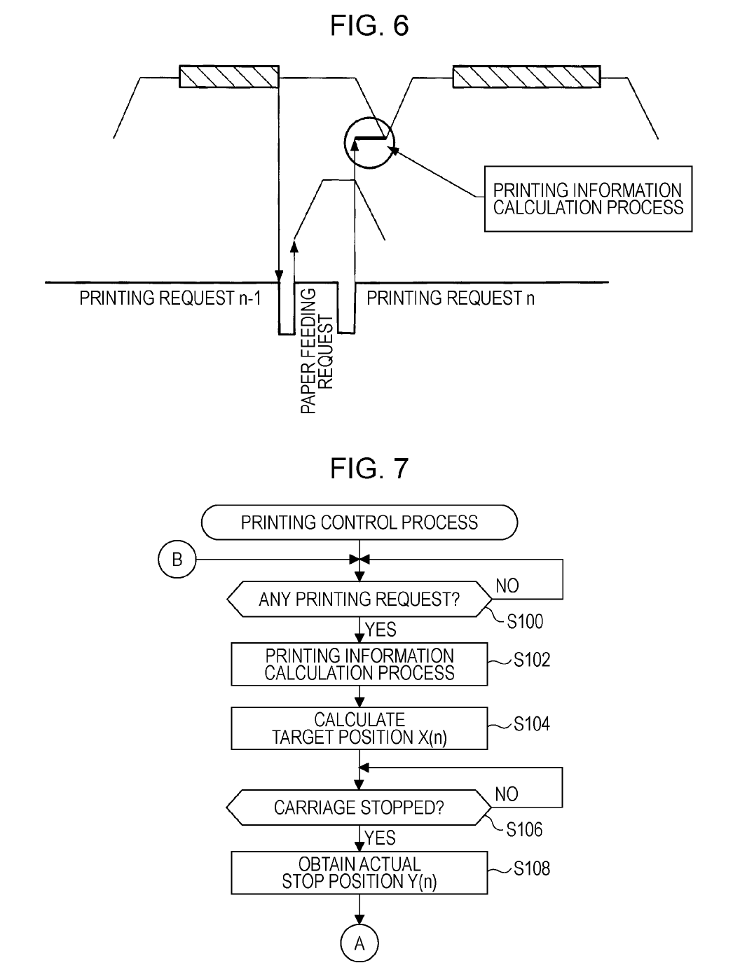

FIG. 6 shows exemplary operational waveforms of the carriage motor 9 and the paper feeding motor 10 according to the embodiment. This operation is realized when the CPU 21 appropriately sends necessary command signals to the DC unit 23 and the drivers 29 to 31, as described above.

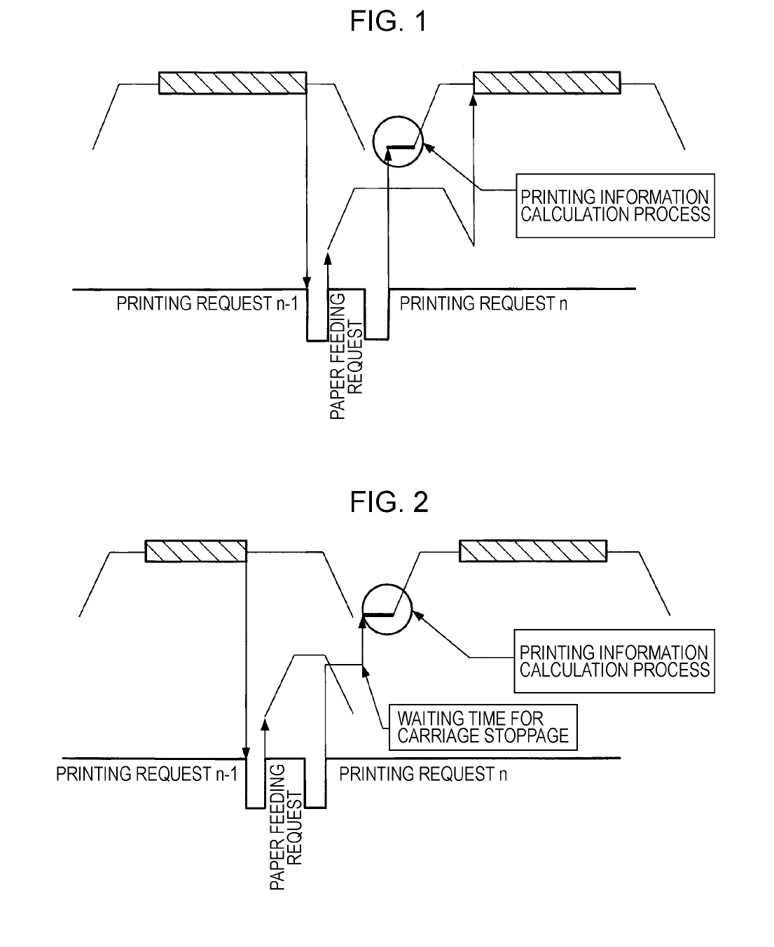

The embodiment differs from the cases shown in FIGS. 1 and 2. As shown in FIG. 6, the CPU 21 executes the printing information calculation process in response to the acceptance of a printing request n for a subsequent printing pass n while the carriage 2 that has finished a printing pass n−1 is still moving. Since the carriage 2 is still moving, the logical seeking process needs to be executed with reference to a target position X(n−1) set for the preceding printing pass n−1, not the actual stop position of the carriage 2, whereby the moving direction of the carriage 2 in the printing pass n is determined. That is, in the embodiment, the moving direction of the carriage 2 in the printing pass n is estimated with reference to the target position X(n−1) in the preceding printing pass n−1.

Thus, as shown in FIG. 6, the printing information calculation process can be executed before the carriage 2 stops. Accordingly, compared to the case where the printing information calculation process is executed after the carriage 2 stops, the waiting time before the carriage 2 starts to move can be reduced. Consequently, the total printing time can be reduced.

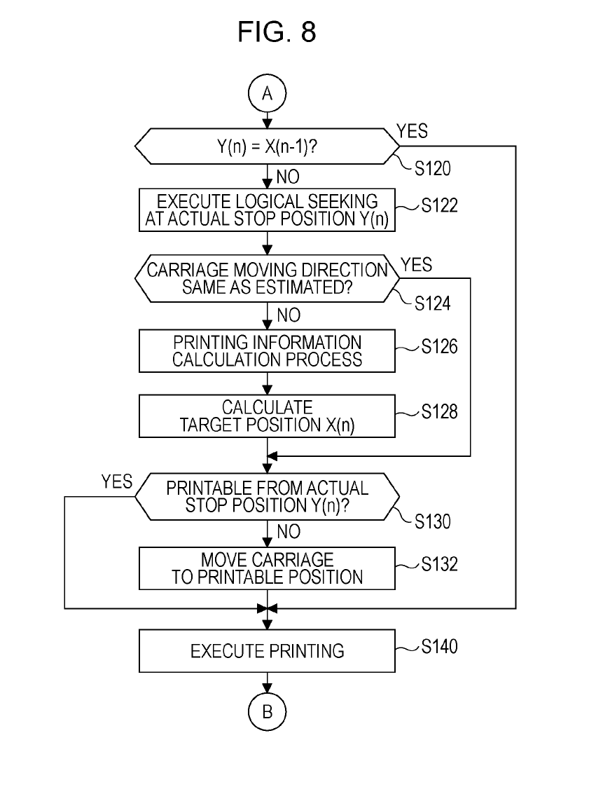

Next, referring to FIGS. 7 and 8, a printing control process performed by the printer 1 according to the embodiment so as to realize the operation shown in FIG. 6 will be described. The printing control process is realized when the CPU 21 reads a printing control processing program stored in the PROM 24 and executes the same. Once the printer 1 is powered on and activated, the printing control process is continuously performed.

As shown in FIG. 7, the printer 1 checks whether or not a new printing request has been accepted (step S100). If not (NO in step S100), the printer 1 stands by while repeating step S100.

If a new printing request has been accepted (YES in step S100), the printer 1 executes the printing information calculation process (step S102). As described above, in step S102, since the carriage 2 is still moving, an actual stop position Y(n) of the carriage 2 cannot be obtained yet. Therefore, the printer 1 executes logical seeking assuming that the carriage 2 has stopped at a target position X(n−1) set for the preceding printing pass n−1.

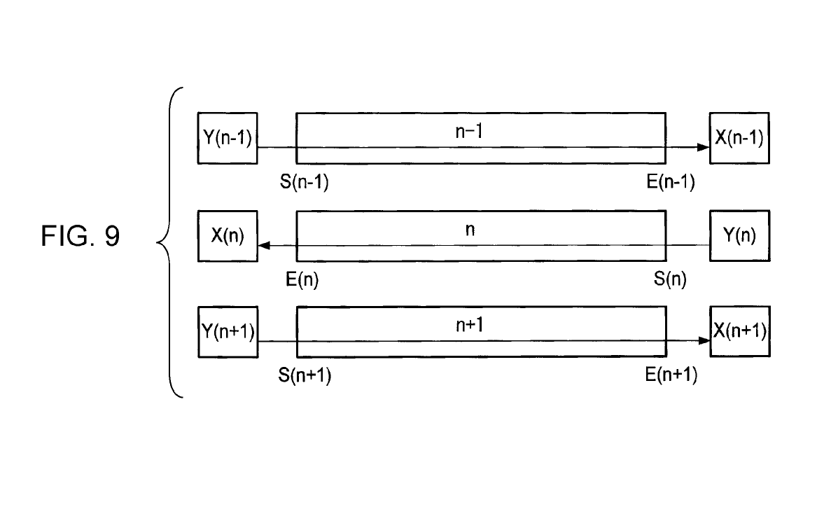

FIG. 9 schematically shows the relationships between printing passes n−1, n, and n+1, target positions X(n−1), X(n), and X(n+1), and actual stop positions Y(n−1), Y (n), and Y (n+1).

As shown in FIG. 9, the carriage 2 executes a printing pass n−1 by driving the print head 6 while moving from an actual stop position Y(n−1), where the carriage 2 has actually stopped, to a target position X(n−1).

Next, the carriage 2 executes a printing pass n by driving the print head 6 while moving from an actual stop position Y(n), where the carriage 2 has actually stopped, to a target position X(n). In this case, the actual stop position Y(n) and the target position X(n−1) should be ideally the same. However, because of errors in driving and controlling the carriage motor 9, there may be a slight difference between the actual stop position Y(n) and the target position X(n−1). Therefore, after the carriage 2 has stopped, the actual stop position Y(n), where the carriage 2 has actually stopped, needs to be obtained.

Likewise, the carriage 2 executes a printing pass n+1 by driving the print head 6 while moving from an actual stop position Y(n+1), where the carriage 2 has actually stopped, to a target position X(n+1). Printing on the paper sheet 8 as a printing medium is performed by repeating such movements of the carriage 2.

In step S102 of the operation performed by the printer 1 of the embodiment, logical seeking is executed in response to the acceptance of a printing request n, assuming that the carriage 2 has stopped at the target position X(n−1) set for the preceding printing pass n−1, whereby the moving direction of the carriage 2 in the printing pass n is temporarily determined. That is, whether printing is to be executed by driving the print head 6 while moving the carriage 2 from right to left or left to right in the main scanning direction is determined.

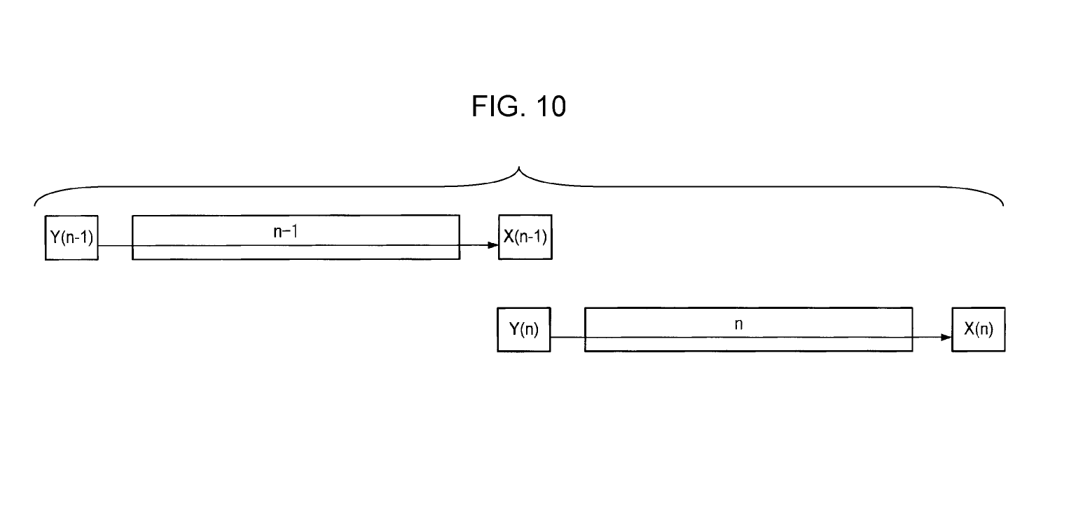

To print in a simple rectangular area on the printing medium, the carriage 2 only needs to be moved back and forth in the main scanning direction as shown in FIG. 9. However, to print in a complicatedly-shaped area as shown in FIG. 10, the moving distance of the carriage 2 may be reduced by moving the carriage 2 from left to right in the printing pass n−1 and further moving the carriage 2 from left to right in the subsequent printing pass n, whereby movement of the carriage 2 may be controlled efficiently. Therefore, logical seeking needs to be executed before execution of the printing pass n so as to determine in which direction the carriage 2 should be moved for more efficient operation.

In step S102 in FIG. 7, a printing start position S(n) and a printing end position E(n) for the printing pass n are calculated on the basis of the printing direction determined from the result of the logical seeking executed with reference to the target position X(n−1) set for the preceding printing pass n−1. Additionally, head-driving waveform data to be supplied to the print head 6 while the carriage 2 is moving from the printing start position S(n) to the printing end position E(n) is generated.

Next, as shown in FIG. 7, the printer 1 calculates a target position X(n) of the carriage 2 for the printing pass n (step S104) on the basis of the result obtained in the printing information calculation process executed in step S102. That is, since the printing end position E(n) for the printing pass n has been calculated, a target position X(n) of the carriage 2 is calculated by taking into account a distance required for stopping the carriage 2 after the completion of printing in which the print head 6 is to be driven from the printing end position E(n).

Next, the printer 1 checks whether or not the carriage 2 has stopped (step S106). If not (NO in step S106), the printer 1 stands by while repeating the checking process of step S106.

If the carriage 2 has stopped (YES in step S106) the printer 1 calculates an actual stop position Y(n), where the carriage 2 has actually stopped (step S108).

Next, referring to FIG. 8, the printer 1 checks whether or not the target position X(n−1) for the printing pass n−1 matches the actual stop position Y(n), where the carriage 2 has actually stopped (step S120).

If the target position X(n−1) for the printing pass n−1 matches the actual stop position Y(n), where the carriage 2 has actually stopped (YES in step S120), the result of the logical seeking executed in step S102 is proved to be correct. Therefore, printing is executed (step S140) in accordance with the result of the printing information calculation process executed in step S102. In short, printing is continued without reexecuting logical seeking because there is no change in the moving direction of the carriage 2 in the printing pass n.

If the target position X(n−1) for the printing pass n−1 does not match the actual stop position Y(n), where the carriage 2 has actually stopped (NO in step S120), logical seeking is reexecuted at the actual stop position Y(n) (step S122). That is, since the actual stop position deviates from the expected position, logical seeking is reexecuted.

Next, the printer 1 checks whether or not the moving direction of the carriage 2 determined in the logical seeking executed in step S122 matches the moving direction determined in the logical seeking executed in step S102 (step S124).

If not (No in step S124), the printing information calculation process is reexecuted on the basis of the moving direction of the carriage 2 determined in step S122 (step S126). That is, since the moving direction of the carriage 2 has changed, the printing start position S(n) and the printing end position E(n) for the printing request n are recalculated on the basis of the new moving direction. Additionally, head-driving waveform data to be supplied to the print head 6 while the carriage 2 is moving from the printing start position S(n) to the printing end position E(n) is generated.

Further, the printer 1 calculates a target position X(n) of the carriage 2 for the printing pass n (step S128) on the basis of the result in the printing information recalculation process executed in step S126. That is, since the change of the moving direction of the carriage 2 has caused a change of the printing end position E(n), the target position X(n) of the carriage 2 is calculated on the basis of the changed printing end position E(n).

After step S128 or if in step S124 the moving direction of the carriage 2 determined in the logical seeking executed in step S122 is found to match that determined in the logical seeking executed in step S102 (YES in step S124), the printer 1 checks whether or not the printing pass n is executable starting from the actual stop position Y(n) (step S130). That is, the printer 1 checks whether or not, if the carriage 2 starts to move at the actual stop position Y(n), the distance from the actual stop position Y(n) to the printing start position S(n) is sufficient for the carriage 2 to gain a constant moving speed.

If the printing pass n is not executable starting from the actual stop position Y(n) (NO in step S130), the carriage 2 is moved to a position where the printing pass n becomes executable (step S132). That is, the carriage 2 is moved to a position where a distance sufficient for the carriage 2 to gain a constant moving speed is provided before the printing start position S(n).

After step S132 or if in step S130 the printing pass n is found to be executable starting from the actual stop position Y(n) (YES in step S130), the printing is executed (step S140). That is, if the moving direction of the carriage 2 determined in the logical seeking executed in step S122 matches that determined in the logical seeking executed in step S102, printing is executed in accordance with the printing information calculated in step S102 while the carriage 2 is moved in the moving direction determined in the logical seeking executed in step S102. If the moving direction of the carriage 2 determined in the logical seeking executed in step S122 does not match that determined in the logical seeking executed in step S102, printing is executed in accordance with the printing information calculated in step S126 while the carriage 2 is moved in the moving direction determined in the logical seeking executed in step S122.

After step S140, the process returns to step S100 described above, and is restarted therefrom.

Thus, with the printer 1 according to the embodiment, even if the carriage 2 is still moving, or yet to stop, for execution of the printing pass n−1, logical seeking is executed in step S102 using the target position X(n−1) set for the printing pass n−1. Therefore, the printing information calculation process can be executed before the carriage 2 stops. Accordingly, the printing information calculation process can be finished before the carriage 2 stops.

Further, after the carriage 2 stops, whether or not the target position X(n−1) and the actual stop position Y(n) match is checked in step S120. If the two match, printing can be executed immediately in accordance with the printing information that has been calculated. Even if the target position X(n−1) and the actual stop position Y(n) do not match, logical seeking alone is reexecuted at the actual stop position Y(n), where the carriage 2 has actually stopped. In this case, if the moving direction of the carriage 2 remains unchanged, printing is executed in accordance with the printing information calculated in step S102. Therefore, a period from when the carriage 2 stops until when the carriage 2 starts to move again can be minimized.

In general, the error between the actual stop position Y(n) and the target position X(n−1) due to errors in driving and controlling the carriage motor 9 is very small. Therefore, even if there is an error between the actual stop position Y(n) and the target position X(n−1), there is little chance that the moving direction of the carriage 2 is changed after logical seeking. Accordingly, there is little chance that the printing information calculation process needs to be reexecuted in step S126. Usually, it is considered that, immediately after the carriage 2 stops, printing can be executed using the result of the printing information calculation process executed in step S102. To summarize, there is little chance that the carriage 2 stops for execution of the printing information calculation process, whereby the total printing time can be reduced.

The invention is not necessarily limited to the above-described embodiment, and various modifications can be made thereto. Examples will be described. In the above embodiment, if the target position X(n−1) and the actual stop position Y(n) match in step S120, the moving direction of the carriage 2 determined in the logical seeking executed in step S102 on the basis of the target position X(n−1) is considered to match that determined in the logical seeking executed on the basis of the actual stop position Y(n), whereby execution of the logical seeking in step S122 is omitted. However, the checking process in step S120 may also be omitted. That is, instead of comparing the target position X(n−1) and the actual stop position Y(n), the printer 1 may be configured to check whether or not the moving direction of the carriage 2 determined in the logical seeking based on the target position X(n−1) matches that determined in the logical seeking based on the actual stop position Y(n).

Further, in the above embodiment, the printing information calculation process in step S102 and the printing information recalculation process in step S126 concern calculations of information on the subsequent printing pass n, such as the printing start and end positions and head-driving waveform data to be supplied to the print head 6 mounted on the carriage 2. However, other kinds of necessary information may also be calculated.

Furthermore, in the above embodiment, the invention is applied to an ink jet serial printer. However, the invention may also be applied to serial printers of other types, such as a dot-impact type.

Furthermore, the program for executing the printing control process described in the above embodiment may be recorded on a recording medium, such as a flexible disc, a compact-disc read-only memory (CD-ROM), a ROM, or a memory card, and be widely distributed in a form of a recording medium. In such a case, the above embodiment is realized by causing the printer 1 to read and execute the program recorded on the recording medium.

Furthermore, the printer 1 is often provided with other programs, such as an operating system and other application programs. In such a case, to utilize the other programs provided to the printer 1, a program including an instruction for accessing one of the other programs that realizes a process equivalent to that in the above embodiment may also be recorded on the recording medium.

Such a program may also be distributed as a carrier wave over a network, not as a recording medium. When the program transmitted as a carrier wave over a network is received and executed by the printer 1, the above embodiment is realized.

When a program is recorded on a recording medium or is transmitted as a carrier wave over a network, the program is occasionally encrypted or compressed. In such a case, the printer 1 that has read the program from the recording medium or received the carrier wave needs to decrypt or expand the program before executing the program.

Furthermore, the above embodiment concerns the case where the printing control process is realized by software. However, the printing control process may be realized by hardware, such as an application-specific integrated circuit (ASIC). Alternatively, the printing control process may be realized by a combination of software and hardware.

What is claimed is:

1. A serial printer comprising:
a first moving-direction-determining unit that determines a carriage moving direction for a subsequent printing pass that follows a current printing pass, in which a carriage is currently moving, on the basis of a target position at which the carriage is to be stopped in the current pass, the carriage moving direction being determined before the carriage stops;
a first printing-information-calculating unit that calculates printing information necessary for executing the subsequent pass, on the basis of the carriage moving direction determined by the first moving-direction-determining unit;
a second moving-direction-determining unit that determines a carriage moving direction for the subsequent pass on the basis of an actual stop position, at which the carriage actually stops, the carriage moving direction being determined after the carriage stops;
a matching check unit that checks whether or not the carriage moving direction determined by the first moving-direction-determining unit matches the carriage moving direction determined by the second moving-direction-determining unit; and
a printing execution unit that executes printing in accordance with the printing information calculated by the first printing-information-calculating unit, the printing being executed if the matching check unit determines that the carriage moving direction determined by the first moving-direction-determining unit matches the carriage moving direction determined by the second moving-direction-determining unit.

2. The serial printer according to claim 1, further comprising:
a second printing-information-calculating unit that calculates printing information necessary for executing the subsequent pass, on the basis of the carriage moving direction determined by the second moving-direction-determining unit, the printing information being calculated if the matching check unit determines that the carriage moving direction determined by the first moving-direction-determining unit does not match the carriage moving direction determined by the second moving-direction-determining unit,
wherein, if the matching check unit determines that the carriage moving direction determined by the first moving-direction-determining unit does not match the carriage moving direction determined by the second moving-direction-determining unit, the printing execution unit executes printing in accordance with the printing information calculated by the second printing-information-calculating unit.

3. The serial printer according to claim 1, wherein, if the actual stop position of the carriage matches the target position set for the current pass, the matching check unit determines that the carriage moving direction determined by the first moving-direction-determining unit matches the carriage moving direction determined by the second moving-direction-determining unit.

4. The serial printer according to claim 1, wherein, if a printing request for the subsequent pass is accepted, the first moving-direction-determining unit determines the carriage moving direction for the subsequent pass on the basis of the target position of the carriage for the current pass, and the first printing-information-calculating unit calculates the printing information necessary for executing the subsequent pass on the basis of both the carriage moving direction determined by the first moving-direction-determining unit and the printing request for the subsequent pass.

5. The serial printer according to claim 4,
wherein printing on a printing medium is performed by alternately accepting a printing request for a single printing pass and a printing medium transportation request, and
wherein the printing request for the subsequent pass is acceptable while operation for transporting the printing medium is underway in accordance with the printing medium transportation request.

6. The serial printer according to claim 2, wherein the printing information calculated by the first printing-information-calculating unit and the printing information calculated by the second printing-information-calculating unit contain information on the subsequent pass including at least a printing start position, a printing end position, and head-driving waveform data to be supplied to a print head mounted on the carriage.

7. A method for controlling printing operation of a serial printer, the method comprising:
determining a carriage moving direction for a subsequent printing pass that follows a current printing pass, in which a carriage is currently moving, on the basis of a target position at which the carriage is to be stopped in the current pass, the carriage moving direction being determined before the carriage stops;
calculating printing information necessary for executing the subsequent pass, on the basis of the carriage moving direction determined on the basis of the target position of the carriage;
determining a carriage moving direction for the subsequent pass on the basis of an actual stop position, at which the carriage actually stops, the carriage moving direction being determined after the carriage stops;
checking whether or not the carriage moving direction determined on the basis of the target position of the carriage matches the carriage moving direction determined on the basis of the actual stop position of the carriage; and
executing printing in accordance with the calculated printing information if it is determined that the carriage moving direction determined on the basis of the target position of the carriage matches the carriage moving direction determined on the basis of the actual stop position of the carriage.
